(19) United States
(12) Patent Application Publication
(10) Pub. No.: US 2017/0171578 A1
(43) Pub. Date: Jun. 15, 2017

(54) MEDIA CONTENT DELIVERY USING AN OBFUSCATED MANIFEST

(71) Applicant: TELEFONAKTIEBOLAGET LM ERICSSON (PUBL), Stockholm (SE)

(72) Inventors: Donald JOONG, Montreal (CA); Ganish KATYAL, Vallingby, Stockholm (SE)

(73) Assignee: TELEFONAKTIEBOLAGET LM ERICSSON (PUBL), Stockholm (SE)

(21) Appl. No.: 15/118,060

(22) PCT Filed: Feb. 13, 2014
(86) PCT No.: PCT/IB2014/058984

§ 371 Date: Aug. 10, 2016

(51) Int. Cl. H04N 21/234; H04N 21/845; H04L 29/06; H04N 21/262; H04N 21/81

(52) U.S. Cl. CPC H04N 21/23424; H04N 21/26258; H04N 21/812; H04L 65/4084; H04N 21/8456

(57) ABSTRACT

A node (14) for a content delivery network (12), CDN is provided. The CDN (12) is configured to store a plurality of first media segments and a plurality of second media segments different from the first media segments. The node (14) interacts with a device (20), the node (14) includes a reception module (24) configured to receive a manifest request, from the device (20), for media content corresponding to the plurality of first media segments (S100). The node includes a manifest module (30) configured to generate a manifest (48) for the requested media content. The manifest (48) indicates a plurality of modified media segments (50) including the plurality of first media segments and at least one of the plurality of second media segments (S102). The plurality of modified media segments (50) have uniform segment lengths with respect to each other. The node includes a transmission module (22) configured to transmit the manifest to the device for media playout (S104).

### TECHNICAL FIELD

The present disclosure relates to delivery of media content, and in particular to a method and system for Adaptive Bitrate (ABR) delivery of media content using an obfuscated manifest.

### BACKGROUND

Internet Protocol Television (IPTV) continues to grow at a rapid pace. IPTV allows for Internet television and/or radio to be delivered to a user device using the architecture and networking methods of the Internet Protocol Suite over a packet-switched network infrastructure. IPTV delivery on managed networks/services is done using a Moving Picture Experts Groups 2 Transport Stream (MPEG2TS) container format over Internet Group Management Protocol (IGMP) for Linear TV/broadcast content delivery and Real Time Streaming Protocol (RTSP) based streaming for on demand content delivery.

Recent years have seen the proliferation of more and more unmanaged devices for IPTV, i.e. devices that are not provided by the network operator, that are capable of playing video/streaming content and consuming content over managed and/or unmanaged, i.e., open internet, networks. The basic trait of an unmanaged network or open internet, is the use of “best effort” mechanism to get content. For video delivery where quality of experience (QoE) is dependent on a constant playout, i.e., streaming media, media delivery over HTTP with Adaptive Bitrate (ABR) mechanism, is used, where the media content is divided into small segments and encoded at different bitrates. At playout, the client device is provided with a list of available media content segments and various bit rates such that the client can go up or down in size of segments that the client devices fetches during playout. The client controls playout by requesting specific segments one after another. While this leads to varying resolution of the video playout, the playout is constant, which is a more acceptable QoE than buffering whenever the best effort network capacity is not enough.

With reference to FIGS. 1-2, ABR delivery uses a manifest file 8 that carries information on different segments and respective bitrates for each segment such as to allow a client device to stream media content by requesting segments at one or more bitrates. The information in manifest file 8 includes a segment name such as “bitrate1.seg1.ts” that indicates the bitrate and segment number. Manifest file also includes a tag (“#extinf”) that specifies the duration of the media segment in seconds. For example, “bitrate2.seg1.ts” and “#extinf=120” indicates a media segment at the second bitrate having a duration of 2 minutes. As another example, “bitrate1.seg.4.ts” and “#extinf=60” (not shown in manifest file 8) would indicate a media segment at a first bitrate having duration of 1 minute.

Manifest file 8 is transferred to client device upon request such the client device can request media segments according to manifest file 8. Manifest file 8 may indicate media content which is not part of the requested content such as commercial, i.e., advertising, content. In cases, where the ABR delivery is used, streaming resources are used per incoming client request, i.e., unicast.

However, existing ABR delivery procedures is not without faults. In particular, manifest based ABR delivery, even though dictated by the server side (server side generates manifest) is left in the hands of the client device/media player. The playout component in the client device can decide to jump segments, i.e., commercial content such as segment 4 in FIG. 2, and/or can apply its own logic on what order to play segments since the segment boundaries between user requested content and non-user requested content (e.g., advertisements) are made clear by manifest file 8. In other words, the client device can look through manifest file 8 of segments 1-4 and determine based on the varying segment lengths, e.g., 1 minute vs 2 minutes in FIGS. 1-2, where the commercials are located.

In another example, program content is broken into 5 second segments and advertising content is broken into 30 second segments. The client device can identify a break of six 30 s segments and just skip over the segments after the break. Even if the advertising content was broken into 5 second segments, the client device could search the manifest file for a segment that is not 5 seconds long to indicate that the following segment is the start of a commercial, i.e., end of requested content is usually shorter in length then the other segments of the requested content. This leads to scenarios where advertisements, campaign videos or rating videos get “trimmed” as the client devices hops to the next available segments (skipping ads and other content streams).

The problem of guaranteeing commercial playout resides in the fact the end-user client has the ability to apply sufficient logic to determine where to break out of the purely linear playout behavior. One solution to skipping advertisements in ABR delivery involves using service provider clients that are able to read extra mark up in a manifest that disables fast forwarding/skipping streams However, in this case, the hacker community simply designs media players that understand the additional markup and are therefore able to skip the extra markup enforcements. Other existing solutions to the problem of advertisement skipping in the ABR delivery mechanism continue to fall short and lead to breakage of service provider desired service delivery. This leads to several key aspects in ABR delivery becoming compromised including insertion of advertisements or other form of playlists related benefit, targeted advertisement benefit and enforcements/rules around skipping, fast forwarding, etc. While media providers may simply orchestrate streams on the server side and send the pre-orchestrated media downstream, this would obviate the basic benefit of playout from caches and being able to go up/down in bitrate, thereby compromising ABR delivery.

### SUMMARY

The present disclosure advantageously provides a system, node, device and methods for media content delivery, and in particular to providing delivery of media content using an obfuscated manifest.

In accordance with one aspect of the disclosure, a system for a content delivery network, CDN, is provided. The CDN is configured to store a plurality of first media segments and a plurality of second media segments different from the first media segments. The system includes a manifest management node that includes a first processor and a first memory. The first memory contains instructions executable by the first processor are configured to cause the manifest management node to accept a manifest request, from a device, for media content corresponding to the plurality of first media segments and generate a manifest for requested media content. The manifest indicates a plurality of modified media segments including the plurality of first media segments and at least one of the plurality of second media segments. The plurality of modified media segments have uniform segment lengths with respect to each other. The instructions executable by the first processor that are configured to cause the manifest management node to transmit the manifest to the device for media playout.

In one embodiment of this aspect, the system includes a media server in communication with the device. The media server includes a second processor and a second memory. The second memory contains instructions executable by the second processor that are configured to cause the media server to accept a request, from the device, for the at least one modified media segment and cause retrieval of at least one first media segment and at least one second media segment corresponding to the requested at least one modified media segment from the CDN. The instructions executable by the second processor that are configured to cause the media server to transmit the at least one first media segment and the at least one second media segment as the requested modified media segment to the device.

In another embodiment of this aspect, the at least one second media segment is at least one advertisement segment. In another embodiment of this aspect, at least one modified media segment includes at least one first media segment and at least one advertisement segment. In another embodiment of this aspect, the manifest indicates a plurality of available bitrates for each modified media segment. The instructions executable by the first processor are further configured to cause the manifest management node to transmit at least one of the modified media segments at one of the plurality of bitrates and at least another of the modified media segments at another of the plurality of bitrates for adaptive bitrate transmission. In another embodiment of this aspect, each individual modified media segment has a larger segment length than each individual first media segment.

In another embodiment of this aspect, the instructions executable by the first processor are further configured to cause the manifest management node to detect a request, from the device, for the at least one modified media segment, cause retrieval of at least one first media segment and at least one second media segment corresponding to the requested at least one modified media segment from a media node in the CDN and transmit the requested at least one first media segment and the at least one second media segment as the modified media segment. In another embodiment of this aspect, the segment lengths are time segment lengths.

In accordance with another aspect of the disclosure, a method for a content delivery network, CDN, is provided. The CDN is configured to store a plurality of first media segments and a plurality of second media segments different from the first media segments. A manifest request, from a device, for media content corresponding to the plurality of first media segments is accepted. A manifest for requested media content is generated. The manifest indicates a plurality of modified media segments including the plurality of first media segments and at least one of the plurality of second media segments. The plurality of modified media segments have uniform segment lengths with respect to each other. The manifest to the device for media playout is transmitted.

In one embodiment of this aspect, a request, from the device, for a modified media segment is accepted. Retrieval of at least one first media segment and at least one second media segment corresponding to the requested modified media segment from a media node in the CDN is caused. The at least one first media segment and the at least one second media segment are transmitted as the requested modified media segment to the device. In another embodiment of this aspect, the at least one second media segment is at least one advertisement segment. In another embodiment of this aspect, at least one modified media segment includes at least one first media segment and at least advertisement segment.

In another embodiment of this aspect, the manifest indicates a plurality of available bitrates for each modified media segment. At least one of the modified media segments at one of the plurality of bitrates and at least another of the modified media segments at another of the plurality of bitrates are transmitted for adaptive bitrate transmission. In another embodiment of this aspect, each individual modified media segment has a larger segment length than each individual first media segments. In another embodiment of this aspect, the segment lengths are time segment lengths.

In accordance with another aspect of the disclosure, a node for a content delivery network, CDN, is provided. The CDN is configured to store a plurality of first media segments and a plurality of second media segments different from the first media segments. The node interacts with a device. The node includes a reception module configured to receive a manifest request, from the device, for media content corresponding to the plurality of first media segments. The node includes a manifest module configured to generate a manifest for the requested media content. The manifest indicates a plurality of modified media segments including the plurality of first media segments and at least one of the plurality of second media segments. The plurality of modified media segments have uniform segment lengths with respect to each other. The node includes a transmission module configured to transmit the manifest to the device for media playout.

In one embodiment of this aspect, the at least one second media segment is at least one advertisement segment. In another embodiment of this aspect, at least one modified media segment includes at least one first media segment and at least advertisement segment. In another embodiment of this aspect, each individual modified media segment has a larger segment length than each individual first media segment. In another embodiment of this aspect, the modified media segment includes at least two first media segments and at least one second media segment temporally located between the at least two first media segments.

In another embodiment of this aspect, for media playout: the reception module is further configured to receive a request, from the device, for the at least one modified media segment. A media module is configured to cause the retrieval of at least one first media segment and at least one second media segment corresponding to the at least one modified media segment. The transmission module is further configured to transmit the at least one first media segment and the at least one second media segment as the modified media segment.

In another embodiment of this aspect, the manifest indicates a plurality of available bitrates for each modified media segment and the transmission module is further configured to transmit at least one of the modified media segments at one of the plurality of bitrates and at least another of the modified media segments at another of the plurality of bitrates for adaptive bitrate delivery.

In accordance with another aspect of the disclosure, a device for media playout of content from a content delivery network, CDN, is provided. The CDN is configured to store a plurality of first media segments and a plurality of second media segments different from the first media segments. The device includes a processor and a memory. The memory contains instructions executable by the processor are configured to cause the device to detect a network condition and determine at least one suggested media segment characteristic for media playout. The at least one suggested media segment characteristic is based on the detected network condition. The instructions executable by the processor that are configured to cause the device to transmit a manifest request for media playout of the plurality of first media segments. The manifest request includes the at least one suggested media segment characteristic.

In one embodiment of this aspect, the instructions executable by the processor are further configured to cause the device to accept a received manifest. The manifest indicates a plurality of modified media segments. The plurality of modified media segments indicates the plurality of first media segments and at least one of the plurality of second media segments. The plurality of modified media segments have uniform segment lengths with respect to each other. The instructions executable by the processor are further configured to request at least one modified media segment for media playout based on the manifest.

In another embodiment of this aspect, the plurality of modified media segments conform to the at least one suggested media segment characteristic. In another embodiment of this aspect, the at least one suggested media segment characteristic includes a media segment length. In another embodiment of this aspect, the plurality of modified media segments have a media segment characteristic other than the at least one suggested media segment characteristic.

In accordance with another aspect of the disclosure, a method for media playout of content from a content delivery network, CDN, is provided. The CDN is configured to store a plurality of first media segments and a plurality of second media segments different from the first media segments. A network condition is detected.

At least one suggested media segment characteristic for media playout is determined. The at least one suggested media segment characteristic being based on the detected network condition. A manifest request for media playout of the plurality of first media segments is transmitted. The manifest request including the at least one suggested media segment characteristic.

In one embodiment of this aspect, a received manifest is accepted. The manifest indicates a plurality of modified media segments. The plurality of modified media segments indicates the plurality of first media segments and at least one of the plurality of second media segments. The plurality of modified media segments have uniform segment lengths with respect to each other. At least one modified media segments for media playout is requested based on the manifest. In another embodiment of this aspect, the plurality of modified media segments conform to the at least one suggested media segment characteristic. In another embodiment of this aspect, the at least one suggested media segment characteristic includes a media segment length. In another embodiment of this aspect, the plurality of modified media segments do not conform to the at least one suggested media segment characteristic.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a manifest file for Adaptive Bitrate delivery according to existing solutions;

FIG. 2 is a diagrammatic representation of the manifest file for Adaptive Bitrate delivery according to existing solutions;

FIG. 3 is a block diagram of a communication system having manifest generation and manifest based streaming in accordance with the principles of the present invention;

FIG. 4 is a block diagram of an alternative communication system having manifest generation and manifest based streaming in accordance with the principles of the present invention;

FIG. 5 is signaling flow diagram of manifest generation and provisioning in accordance with the principles of the present invention;

FIG. 6 is a manifest file having modified media segments in accordance with the principles of the present invention;

FIG. 7 is a diagrammatic representation of the manifest file having modified media segments in accordance with the principles of the present invention;

FIG. 8 is a signaling flow diagram of the manifest generation process in accordance with the principles of the present invention;

FIG. 9 is a signaling flow diagram of the orchestration process for proxy streaming modified media segments; and

FIG. 10 is a signaling flow diagram for suggesting one or more media characteristics for manifest generation.

### DETAILED DESCRIPTION

As used herein, relational terms, such as “first” and “second,” “top” and “bottom,” and the like, may be used solely to distinguish one entity or element from another entity or element without necessarily requiring or implying any physical or logical relationship or order between such entities or elements.

In embodiments described herein, the joining term, “in communication with” and “connected to,” and the like, may be used to indicate a path for data communication, which may be accomplished by physical contact, induction, electromagnetic radiation, radio signaling, infrared signaling or optical signaling, for example. The above methods of achieving data communication are non-limiting and mentioned only for illustration. One having ordinary skill in the art will appreciate that multiple components may interoperate and modifications and variations are possible of achieving the electrical and data communication.

The present invention advantageously provides a system, node, device and methods for Adaptive Bitrate (ABR) delivery of media content using an obfuscated manifest. The present invention advantageously allows Internet Protocol television (IPTV), over-the-top (OTT) and managed TV service providers to have precise control over playout of media content including ABR based streaming formats that have content including user requested media content and non-user requested media content. This allows for server side orchestration of media streams that helps prevent or make difficult client side manipulation of media streams such as jumping/seeking across advertisement segments. Further, the present invention advantageously offers manifests that are obfuscated or made unclear as to the actual segment boundaries between requested media content and other media content, e.g., advertisements or non-user requested content, that are weaved into a media stream without hindering the benefit of having adaptive media playout switching across various segments that are encoded at different bitrates, i.e., does not hinder ABR delivery. Therefore, the present invention advantageously provides the benefits of targeted advertisement/content streams in a unicast based delivery environment without comprising the benefits of ABR downstream delivery.

Accordingly, the system, node, device and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description.

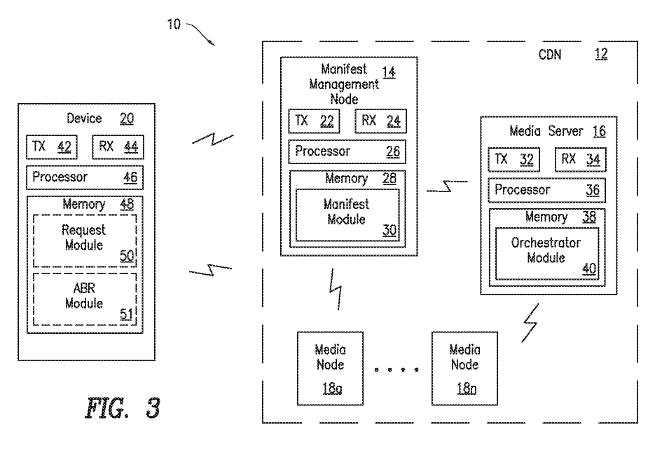

Referring now to drawing figures in which like reference designators refer to like elements there is shown in FIG. 3 an exemplary communication system having manifest generation and manifest based streaming constructed in accordance with the principles of the present invention and designated generally as “10.” System 10 includes one or more Content Distribution Networks, CDNs, 12 for providing requested media content. CDN 12 may include one or more manifest management nodes 14, media servers 16 and media nodes 18a-18n (referred to collectively herein as media node 18), among other nodes and servers.

Manifest management node 14 is in communication with media server 16, media node 18 and/or device 20. Manifest management node 14 includes one or more transmitters 22, i.e., transmission module 22, and one or more receivers 24, i.e., reception module 24, for communicating with media server 16, media node 18 and device 20, among other nodes, servers and devices. Manifest management node 14 further includes one or more processors 26 that are configured to perform manifest management node 14 functionality describe herein. Manifest management node 14 includes memory 28 that may include volatile and non-volatile memory. For example, non-volatile memory may include a hard drive, flash memory, memory stick and the like. Also, volatile memory may include random access memory and other known in the art. Memory 28 may store program instructions, which when executed by processor 26, provide the functionality described herein for manifest module 30.

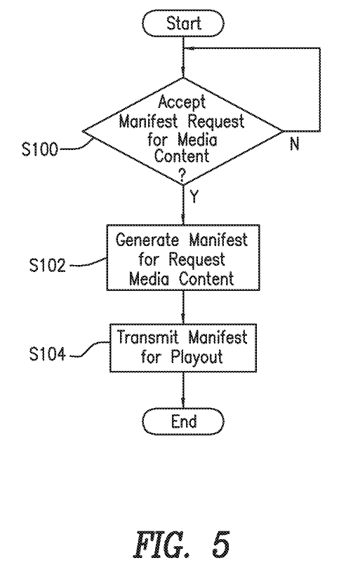

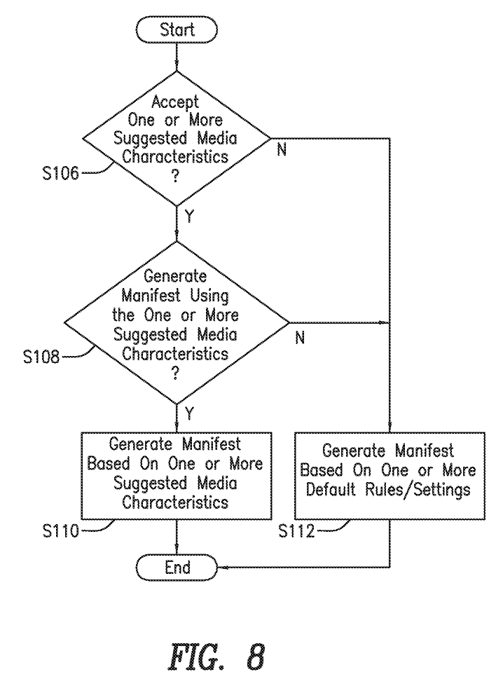

For example, manifest module 30 includes instructions, which when executed by processor 26, causes processor 26 (manifest management node 14) to perform the manifest generation and provisioning process, discussed in detail below with reference to FIGS. 5 and 8.

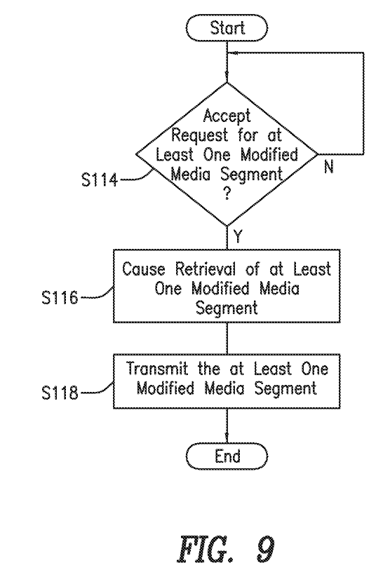

Media server 16 may be in communication with manifest management node 14, media node 18 and/or device 20, among other servers, nodes and devices. Media server 16 may include one or more transmitters 32, one or more receivers 34, one or more processors 36 and memory 38 that generally correspond to components of manifest management node 14, with size and performance being adjusted based on design needs, while providing the functionality described herein with respect to media server 16. For example, memory 38 includes orchestrator module 40, i.e., media module 40, among other modules. Orchestrator module 40 includes program instructions, which when executed by processor 36, causes processor 36 to perform the media content orchestrator/transmission process described in detail with respect to FIG. 9.

Media node 18 may be in communication with manifest management node 14, media server 16, other media nodes 18 and/or device 20, among other nodes, servers and devices. Media nodes 18 are HTTP streaming servers or caches in CDN 12 that store and deliver unicast media streams. Requested media content, i.e., first media segments, and non-user requested media content such as advertisements, statutory warning clips, campaign clips and/or other media content that was not requested by the user, i.e., second media segments. In one embodiment, the first media segments are different in type from the second media segments.

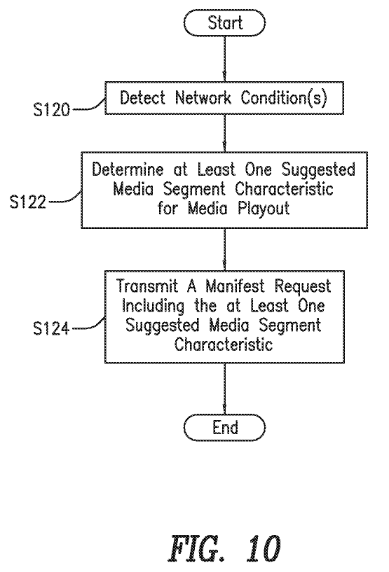

Device 20 includes one or more transmitters 42, and one or more receivers 44 for communicating with manifest management node 14, media server 16, media node 18, CDN 12 and other devices 20, among other servers, nodes and devices. Device 20 includes one or more processors 46 and memory 48 that generally correspond to components of manifest management node 14, with size and performance being adjusted based on design needs, while providing the functionality described herein with respect to device 20. For example, memory 48 includes request module 50, among other modules. Request module 50 includes program instructions, which when executed by processor 46, causes processor 46 to perform manifest request process described in detail with respect to FIG. 10. Further, device 20 may include an ABR module 51 that includes instructions, which when executed by processor 46 causes processor 46 to determine whether a manifest has been received, i.e., whether to accept a manifest, and request at least one modified media segment, discussed below with respect to FIG. 10, for media playout based on the manifest.

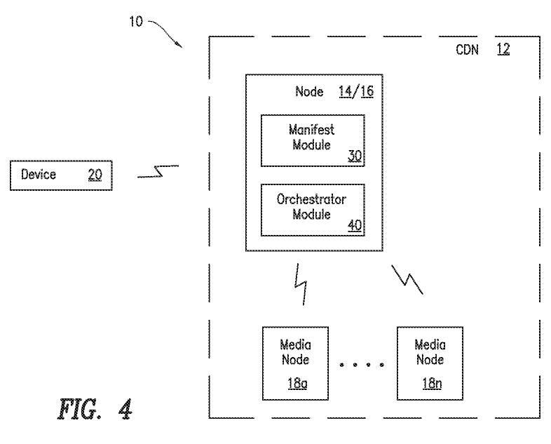

While manifest management node 14 and media server 16 are illustrated in FIG. 3 as being part of CDN 12, in one embodiment manifest management node 14 and/or media server 16 may be separate from CDN 12 such as part of different networks. Further, functionality of manifest management node 14 and media server 16 may be performed by the same physical device, node or server based on design implementation, as illustrated in one example in FIG. 4.

An exemplary process for manifest generation and provisioning is described with reference to FIG. 5. Processor 26 determines whether a request for media content has been received, i.e., determines whether to accept a manifest request message (Block S100). For example, manifest management node 14 may receive a manifest request message from device 20 that indicates device 20 is requesting a manifest for playout of media content specified in the request corresponding to first media segments. In one embodiment, the request includes suggested media segment characteristics, discussed below in detail. If a manifest request message has not been received, processor 26 repeats the determination of Block S100. The manifest request process is discussed in detail with respect to FIG. 10.

In response to the request, processor 26, via manifest module 30, generates a manifest for the requested media content (Block S102). The manifest generation process is described in detail with respect to FIG. 8. The manifest that is generated for requested media content indicates modified media segments including the first media segments (user requested media content) and/or second media segments (non-user requested media content). Each modified media segment may correspond to one or more first media segments and/or one or more second media segments. For example, modified media segment seg2 in FIG. 7, discussed in detail below, includes original segment 3 (user requested content), segment 4 (non-user requested media content) and segment 5 (non-user requested media content). In another example, modified media segment seg 1 in FIG. 7 includes original segment 1 (user requested content) and segment 2 (user requested content). The original segments that compose the modified media segment may vary depending on implementation but the boundaries between user requested content and non-user requested content remain blurred. Further, the order of first media segment(s) and segment media segment(s) indicated in a modified media segment may vary based on implementation. For example, the modified media segment may indicate or include at least two first media segments and at least one second media segment temporally located between the at least two first media segments. In one embodiment, the modified media segments in the manifest has uniform segment lengths with respect to each other. In one embodiment, segment lengths are time segment lengths. In one embodiment, the manifest indicates the modified media segments according to predefined manifest settings that may include making the modified media segments having equal time segment lengths with respect to each other, or varying the size of the modified media segments. Further, the manifest may indicate one or more bitrates for each modified media segment such as to allow for ABR delivery.

Each modified media segment indicates one or more requested media content segments, one or more other media content segments, e.g., advertisements or non-user requested content, or both user requested content segment(s) and non-user requested content in which the modified media segments have uniform time segment lengths with respect to each other. In one example, assume there are only two requested media content segments of 30 seconds and 10 seconds, respectively, left to transmit to the device for media playout. The second to last modified media segment in the manifest may indicate a requested media content segment of 30 seconds that is treated as a single modified media segment of 30 seconds for media playout. The last modified media segment in the manifest may indicate the last requested media content segment of 10 seconds and an advertisement segment of 20 seconds that are treated as a single modified media segment of 30 seconds for media playout. Therefore, media player logic based on time segment length differentiation will be unable to differentiate the second to last modified media segment from the last modified media segment based on time/length characteristics of a media segment. In contrast, existing manifest solutions would simply have lists individual media segment lengths of 30 seconds (2^{nd} to last segment), 10 second (last segment) and 20 seconds (advertisement segment), thereby making unwanted jumping of advertisement segments possible, i.e., segment boundaries between content are clear.

Processor 26 causes the generated manifest to be transmitted to device 20 for media playout (Block S104). Device 20 uses the generated manifest according to known ABR delivery procedures in which device 20 fetches modified media segments from the network, e.g., media server 16, at one or more bitrates. Each fetched modified media segment may map to one or more segments on the media server side but the client/device 20 does not know how many and what type of segments are mapped to each modified media segment. This obfuscating of mapped media segments helps maintain desired playout behavior at client/device 20 since device 20 does not know which modified media segment includes the advertisement segment(s), thereby rendering ad skipping impractical, i.e., ad skipping or fast forwarding using the manifest with modified media segments will lead to missing requested media content segments.

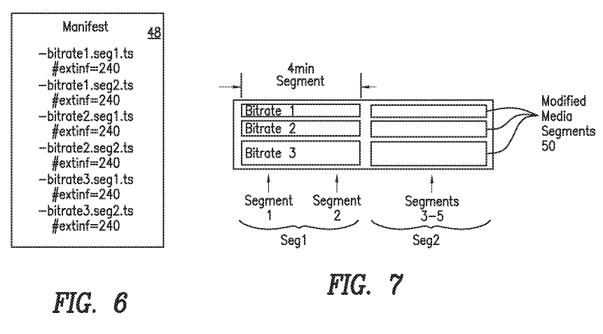

FIGS. 6-7 illustrate manifest 48 and a diagrammatic representation of manifest 48 generated in accordance with the principles of the present invention. Manifest 48 indicates a plurality of modified media segments 50 having uniform length to each other. In this example, each modified media segment is four minutes in length and is available in three different bitrates. Modified media segment seg2 includes media segments 3-5 that correspond to original segment 3 (end of user requested media), segment 4 (advertisement or non-user requested media) and segment 5 (advertisement or non-user requested media) such that modified media segment seg2 has the same time segment length as modified media segment seg1, thereby blurring or obfuscating the segment boundaries between user requested media content and non-user requested media content.

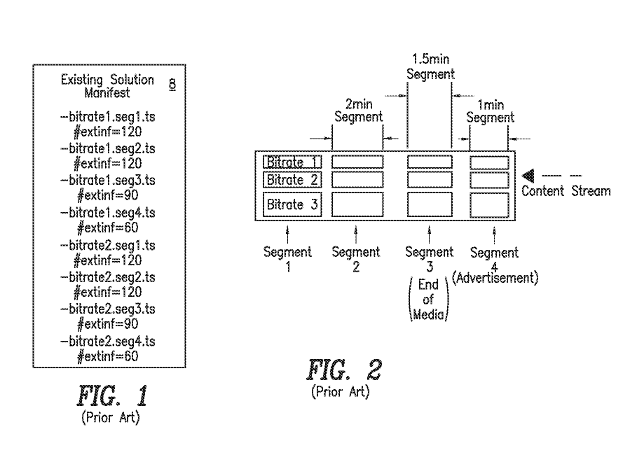

While each bitrate is shown having four minute segments, different bitrates may have different segments lengths in which segments of a respective bitrate are uniform to each other. In other words, obfuscated manifest 48 makes unclear where user requested media segments and other media content segments boundaries are, thereby reducing the chance of advertisement skipping or jumping, among other unwanted media playout behaviors. In contrast to FIGS. 6-7, existing manifest procedures (see FIGS. 1-2) make clear where these segment boundaries exist by leaving the time length of segment 3 and segment 4 shorter than segments 1-2, thereby indicating that segment 3 is likely the end of the requested media content and segment 4 is likely an advertisement segment, as illustrated in FIGS. 1-2. While FIGS. 6-7 illustrate only two modified media segments having four minutes segment lengths and three different bitrates, manifest 48 may indicate one or more bitrates, one or more time segment lengths and/or one or more modified media segments. FIG. 8 illustrates an exemplary manifest generation process of Block S102 for generating a manifest with/without one or more media segment characteristics that may be suggested by device 20. Processor 26 determines whether one or more suggested media segment characteristics are included in the manifest request message, i.e., whether to accept a manifest request including one or more suggested media characteristics (Block S106). If one or more suggested media segment characteristics are included in the manifest request message, processor 26 determines whether to generate a manifest file using the one or more suggested media segment characteristics based on one or more predefined rules (Block S108). For example, the one or more predefined rules may define a minimum time segment length such that a suggested media characteristics falling below the minimum time segment length will not be incorporated into the manifest.

If processor 26 determines to use one or more suggested media segment characteristics based on the one or more predefined rules, processor 26 generates the manifest file for media playout based on the one or more suggested media segment characteristics, i.e., processor 26 conforms the manifest to one or more of the suggested media segment characteristics (Block S110). In one example, processor 26 generates a manifest that indicates modified media segments having equal time segment lengths where the time segment length is equal to the suggested time segment length received in the manifest request. Other media segment characteristics not suggested by device 20 may be predefined by the network operator or service provider. For example, bit rate support may be defined by a network operator or service provider.

Referring back to Block S106, if the determination is made that the manifest request message does not include one or more suggested media characteristics, processor 26 generates the manifest for media playout based on one or more default parameters such as a minimum time segment length and/or predefined segment lengths/sizes defined in one or more default/enforcement rules (Block S112). Referring back to Block S108, if the determination is made not to use the one or more suggested media segment characteristics, processor 26 performs Block S112 such that the manifests may not conform to one or more of the suggested media segment characteristics. For example, manifest management node 14 may try to accommodate the preferred segment size requested by device 20. However, if the request cannot be supported, e.g., the requested segment size is unreasonable when evaluated by processer 26, the request will be ignored and/or rejected. Also, it is contemplated that manifest management node 14 may be configured to support specific modified segment sizes in order provide effective, i.e., efficient, caching within the network. As such, manifest management node 14 may ignore and/or reject the preferred segment size requested by device 20 if the requested preferred segment size is not one of the specifically supported sizes.

FIG. 9 illustrates an orchestrator process for proxy streaming modified media segments to device 20. Processor 36 determines whether a request for at least one modified media segment has been received, i.e., whether to accept a request, from the device, for the at least one modified media segment (Block S114). With reference to the example of FIGS. 6-7, device 20 may request at least modified media segment 1 at the second bitrate for media playout. If processor 36 determines a request has not been received for at least one modified media segment, processor 36 repeats the determination of Block S114.

If processor 36 determines a request for at least one media segment has been received, processor 36 causes retrieval of at least one first media segment (user requested media) and/or at least one second media segment (non-user requested media content) corresponding to the requested at least one modified media segment from media node 18 in CDN 12 (Block S116). For example, requested media content segments may be stored as two second segments in media node 18 but if the generated manifest indicates modified media segments have ten second segments, device 20 requests at least one ten second modified media segment. In one instance, processor 36 may retrieve five two second segments of user requested content from media node 18 for a single incoming modified media segment request. In another instance using the same manifest, processor 36 may retrieve a single two second segment of requested media content from media node 18 for a single incoming request and a single eight second advertisement segment from the same or a different media node 18.

Segments are dynamically retrieved, i.e., retrieved on the fly, such as to allow for targeted advertising. The advertisements selected for retrieval may be based on characteristics of the user and/or characteristics of device 20, among other factors that allow for media server 16 to provide targeted commercial/advertisement content. Processor 36 causes the at least one modified media segment to be transmitted or streamed to device 20 (Block S118). For example, processor 36 causes transmission of at least one first media segment (user requested media) and/or the at least one second media segment (non user requested media content) as the requested modified media segment to the device. In one example, the at least one second media segment may be at least one advertisement segment. In another example, the at least one modified media segment includes at least one first media segment and at least one advertisement segment. In one embodiment, each individual modified media segment has a larger segment length than each individual first media segment.

In the instances discussed above, media server 16 will stream down a single ten second modified media segment, i.e., stream the retrieved five two second segments, and then stream down another single ten second segment, i.e., stream the retrieved two second segment and eight second advertisement segment such that device 20 is only able to determine the boundaries between modified media segments and not the original segments. Blocks S116-S110 may alternatively be performed by manifest management node 14, media node 18 or CDN 12, among other nodes, servers and networks that are configured to perform the orchestration process.

Further, device 20 may include request module 50 that advantageously allows device 20 to suggest media segment characteristics such as media segment lengths to CDN 12 or manifest management node 14 for media content playout. This allows a manifest to be generated based on network and/or device conditions specific to device 20, thereby helping increase the QoE of the user of device 20.

FIG. 10, illustrates the request process of request module 50 for suggesting one or more media characteristics for manifest generation. Processor 46 causes network condition(s) to be detected (Block S120). For example, device 20 may detect network conditions itself and/or may receive network condition report(s) from a node or server in the network. For example, device 20 may detect that bandwidth in the network is volatile or unstable or that the network bandwidth or channel conditions remain poor, i.e., noisy channel, weak signal, etc.

Processor 46 determines at least one suggested media segment characteristic for media playout based at least in part on the detected network condition(s) (Block S122). For example, if the bandwidth in the network is volatile or unstable, device 20 may request smaller segment lengths than a predefined standard/default size such that device 20 can keep switch up or down bitrates without requiring buffering a substantial amount of video at a resolution which is not the best possible resolution. In another example where the network conditions remain poor over a predetermined period of time, device 20 may request larger segment sizes, e.g., n*10, but stay at a lower bitrate instead of requesting smaller media segments of lowest bitrate every n seconds. While the suggested media segment characteristic is described in terms of segment length, the suggested media segment characteristic may include other media segment parameters.

Processor 46 causes the manifest request message including the at least one suggested media segment characteristic to be transmitted to manifest management node 14 for manifest generation (Block S124). In other words, the instant invention advantageously allows device 20 to suggest at least one media segment characteristic that may be taken into account during manifest generation. Therefore, allowing device 20 to suggest a preferred media segment sizes that better suits device 20 based on network performance and device 20 capacity, without being limited to a media server 16 enforced segment size. Alternatively, device 20 may choose, instead of suggesting, the preferred media segment size. In another alternative embodiment, device 20 may not use request module 50, and may instead request the manifest file in accordance with existing ABR delivery procedures.

The described arrangements advantageously allow insertion of “other content” or non-user requested media content (e.g., targeted advertisements) without device 20 being able to distinguish the user requested media content from the other content (non-user requested content) based on media segmentation, thereby reducing the effectiveness of hacky logics to jump or skip over advertisements. Further, the arrangement described herein advantageously provide the benefits of server side (service provider side) orchestrated media streams, without compromising the benefits of ABR delivery, which in turn provides personalized or targeted streams with or without the ABR mechanism. Also, the arrangements described herein advantageously allow device 20 to suggest a preferred segment size without being limited to a server enforce segment size, i.e., default enforce rules.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1-8. (canceled)

9. A method for a content delivery network, CDN, the CDN configured to store a plurality of first media segments and a plurality of second media segments different from the first media segments, the method comprising:
accepting a manifest request, from a device, for media content corresponding to the plurality of first media segments;
generating a manifest for requested media content, the manifest indicating a plurality of modified media segments including the plurality of first media segments and at least one of the plurality of second media segments, the plurality of modified media segments having uniform segment lengths with respect to each other; and
transmitting the manifest to the device for media playout.

10. The method of claim 9, further comprising:
accepting a request, from the device, for a modified media segment;
causing retrieval of at least one first media segment and at least one second media segment corresponding to the requested modified media segment from a media node in the CDN; and
transmitting the at least one first media segment and the at least one second media segment as the requested modified media segment to the device.

11. The method of claim 9, wherein the at least one second media segment is at least one advertisement segment.

12. The method of claim 9, wherein at least one modified media segment includes at least one first media segment and at least advertisement segment.

13. The method of claim 9, wherein the manifest indicates a plurality of available bitrates for each modified media segment; and
the method further comprises transmitting at least one of the modified media segments at one of the plurality of bitrates and at least another of the modified media segments at another of the plurality of bitrates for adaptive bitrate transmission.

14. The method of claim 9, wherein each individual modified media segment has a larger segment length than each individual first media segments.

15. The method of claim 9, wherein the segment lengths are time segment lengths.

16. A node for a content delivery network, CDN, the CDN configured to store a plurality of first media segments and a plurality of second media segments different from the first media segments, the node interacting with a device, the node comprising:
a processor;
a memory storing instructions executable by the processor whereby the node is operable to:
receive a manifest request, from the device, for media content corresponding to the plurality of first media segments;
generate a manifest for the requested media content, the manifest indicating a plurality of modified media segments including the plurality of first media segments and at least one of the plurality of second media segments, the plurality of modified media segments having uniform segment lengths with respect to each other; and
transmit the manifest to the device for media playout.

17. The node of claim 16, wherein the at least one second media segment is at least one advertisement segment.

18. The node of claim 17, wherein at least one modified media segment includes at least one first media segment and at least advertisement segment.

19. The node of claim 16, wherein each individual modified media segment has a larger segment length than each individual first media segment.

20. The node of claim 16, wherein the modified media segment includes:
at least two first media segments; and
at least one second media segment temporally located between the at least two first media segments.

21. The node of claim 16, wherein for media playout, the instructions executable by the processor are further configured to cause the node to:
receive a request, from the device, for the at least one modified media segment;
retrieve at least one first media segment and at least one second media segment corresponding to the at least one modified media segment; and
transmit the at least one first media segment and the at least one second media segment as the modified media segment.

22. The node of claim 16, wherein the manifest indicates a plurality of available bitrates for each modified media segment and the instructions executable by the processor are further configured to cause the node to:
transmit at least one of the modified media segments at one of the plurality of bitrates and at least another of the modified media segments at another of the plurality of bitrates for adaptive bitrate delivery.

23. A device for media playout of content from a content delivery network, CDN, the CDN configured to store a plurality of first media segments and a plurality of second media segments different from the first media segments, the device comprising:
a processor;
a memory, the memory containing instructions executable by the processor that are configured to cause the device to:
detect a network condition;
determine at least one suggested media segment characteristic for media playout, the at least one suggested media segment characteristic being based on the detected network condition; and
transmit a manifest request for media playout of the plurality of first media segments, the manifest request including the at least one suggested media segment characteristic.

24. The device of claim 23, wherein the instructions executable by the processor are further configured to cause the device to:
accept a received manifest, the manifest indicating a plurality of modified media segments, the plurality of modified media segments indicating the plurality of first media segments and at least one of the plurality of second media segments, the plurality of modified media segments having uniform segment lengths with respect to each other; and
request at least one modified media segment for media playout based on the manifest.

25. The device of claim 24, wherein the plurality of modified media segments conform to the at least one suggested media segment characteristic.

26. The device of claim 23, wherein the at least one suggested media segment characteristic includes a media segment length.

27. The device of claim 24, wherein the plurality of modified media segments have a media segment characteristic other than the at least one suggested media segment characteristic.

28-32. (canceled)
